(19) United States
(12) Patent Application Publication
(10) Pub. No.: US 2013/0305590 A1
(43) Pub. Date: Nov. 21, 2013

(54) Device and Method for Controlling Avian Parasites

(71) Applicants: Werner Bessei, Neuhausen (DE); Christina Popp, Kornwestheim (DE); Herbert Bessei, Bad Kreuznach (DE); Angie Manton, Filderstadt-Plattenhardt (DE)

(72) Inventors: Werner Bessei, Neuhausen (DE); Christina Popp, Kornwestheim (DE); Herbert Bessei, Bad Kreuznach (DE); Angie Manton, Filderstadt-Plattenhardt (DE)

(73) Assignee: Universität Hohenheim, Stuttgart (DE)

(21) Appl. No.: 13/988,963

(22) PCT Filed: Nov. 21, 2011
(86) PCT No.: PCT/EP11/70546

§ 371 Date: Aug. 5, 2013

(30) Foreign Application Priority Data
Nov. 22, 2010 (DE) 102010052152.3

(51) Int. Cl. A01M 1/22

(52) U.S. Cl. CPC A01M 1/226
USPC 43/132.1

(57) ABSTRACT

The invention relates to an elongate hollow body (1) for controlling parasites in a bird house, comprising at least one opening (15) in the wall of the hollow body (1) for receiving the parasites in the interior of the hollow body (1), and a means for killing the parasites, arranged detachably in the interior. The means can be activated in a predetermined manner and emits electromagnetic radiation. The invention also relates to a method for controlling parasites in a bird house, in which the hollow body (1) is used.

### FIELD OF THE INVENTION

The invention relates to a device and to a method for controlling parasites in a bird house.

### BACKGROUND OF THE INVENTION

One of the most important problems in keeping birds, both for private and for commercial purposes, is the infestation of the birds with ectoparasites. The birds are attacked inter alia by lice (Phthiraptera) and mites (Acari). The infestation of poultry by members of the parasitizing genus Dermanyssus, such as the poultry red mite (Dermanyssus gallinae) and northern fowl mite (Ornithonyssus sylviarum) is of particular significance. Poultry red mites are nest parasites, which attack host birds at night to suck blood, for about 30 minutes, and then retreat into cracks and crevices in proximity to the host. There they form large groups, commonly termed aggregates, in which they develop and lay their eggs. Poultry red mite does not exhibit host specificity, but infests many different kinds of birds and also mammals, such as pets, sheep and mice, for example. In exceptional cases poultry red mite may also attack humans, thereby transmitting viruses and bacteria, for which the mite acts as a vector.

The infestation of breeding poultry by parasites, in particular by poultry red mite leads to serious economic damage. Affected birds exhibit reduced egg production, increased food consumption, and delayed growth rate. If the mite infestation is severe, the birds suffer acute anaemia, often resulting in death. In addition, mites act as an intermediate host for many pathogens, such as salmonella, spirochetes and pox viruses, so that a mite infestation is frequently accompanied by other diseases.

Conventional control measures are mainly limited to the use of chemical acaricides (DE 10 2005 031 976 A1) and silicate dust (DE 10 2008 006 683 A1). Because of the high toxicity thereof and the ever-increasing legal requirements placed on compatibility of pest control measures (biocide guidelines, pharmaceutical laws) only a few acaricides are allowed. Added to that is the increasing, in some cases multiple resistance of the mites to the commercial acaricides. As an alternative to acaricides, birds and housing systems are therefore treated with silicate dust, which inhibits the movement of the parasites and facilitates their dehydration. The drawback of this treatment is the heavy exposure to dust for animals and humans. In addition, parasite traps with acaricides are used (Chirico J. and Tauson R., 2002, DE 198 08 745 A1), but these have to be replaced on average once a week. This calls for considerable manpower and birds are disturbed by the regular entry to the bird house. Regular and comprehensive cleaning and disinfection of the bird houses is also necessary, for which purpose all the birds have to be moved. These measures are associated with considerable expenditure of time, manpower requirements and financial outlay and lead to additional stress on the birds.

There is therefore a need for an inexpensive device for controlling and preventing the parasitic infestation of birds, use of which requires fewer staff, which is correspondingly inexpensive and does not disturb the daily routine of the birds.

### SUMMARY OF THE INVENTION

The present invention relates to an elongate hollow body for controlling parasites in a bird house, having at least one opening in the wall of the hollow body, for admitting the parasites into the inside of the hollow body, and a means arranged detachably inside for killing the parasites, wherein the means can be activated in a predetermined manner and emits electromagnetic radiation.

The invention relates further to a method for controlling parasites in a bird house by means of a corresponding hollow body, wherein the parasites are killed inside the hollow body, in which they congregate.

### BRIEF DESCRIPTION OF THE FIGURES

FIG. 1A shows an elongate hollow body (1) in cross-section, with an electrical conductor (2) inside. FIG. 1B shows an insulating disc (3).

FIG. 2A shows a perch (11) for birds, having two heating conductors (12) for killing parasites. FIG. 2B shows a thermoplastic insulator (13).

FIG. 3A shows a perch (11) for birds, having a means inside for killing parasites. FIG. 3B shows a detail from FIG. 3A, which shows a sliding carriage (23) in which a microwave transmitter (32) is arranged.

FIG. 4A shows a perch (11) for birds, having a means inside for killing parasites. FIG. 4B shows a detail from FIG. 4A, which shows a sliding carriage (23) in which an infrared lamp (42) is arranged.

### DETAILED DESCRIPTION OF THE INVENTION

A first aspect of the invention concerns an elongate hollow body for controlling parasites in a bird house, having at least one opening in the wall of the hollow body, for admitting parasites into the inside the hollow body, and a means arranged detachably inside for killing the parasites. Because the means can be activated in a predetermined manner and emits electromagnetic radiation, parasites that are located inside the hollow body are killed. The parasites that infest the birds naturally creep through the openings into the interior of the hollow body in order to hide there in the dark. Inside the hollow body the parasites are killed. For that purpose use is made of a means that is arranged inside the hollow body and in the active state emits electromagnetic radiation. The radiation kills the parasites without harming the birds. By using electromagnetic radiation to kill the parasites, there is no need for poisons, insecticides and silicate dust, whereby the harmful effects on health for humans and birds are substantially reduced. Moreover, the means can be activated in a predetermined manner, i.e. it can be specifically switched on and off as often as desired. The electromagnetic radiation is thus not emitted continuously. In addition, according to requirements, the means can be used at freely selectable intervals. Each time the means is started up, the parasites inside are killed, so that repeated activation of the means repeatedly and hence effectively kills parasites. Once installed in the bird house, the hollow body remains there without having to be removed or replaced after the parasites have been killed. In the time between the phases in which the means is activated, the means remains inside the hollow body. The hollow body likewise does not need to be removed from the bird house once the means has been switched off, the result being that unnecessary disturbance to the birds, for example, by persons entering the sheds, can be avoided. If necessary, for cleaning the hollow body or when the bird house is being rearranged, the detachably arranged means can be taken out of the hollow body.

In a preferred embodiment the hollow body is a perching element for birds, preferably a perch or approach perch, more preferred a perch at a resting place within the bird house. Parasites are always found on or in close proximity to their host. If the parasites leave their host, for example, to lay eggs, they remain in the vicinity of the roosting and nesting sites of the host. In the open, birds roost either in nests or on tree branches. In aviculture, such roosting sites are provided by perching elements such as boards, perches or approach perches. Conventional perching elements are completely sealed off and have neither holes nor openings such that no potential refuges for parasites are provided. In contrast, the hollow body according to the invention has at least one opening in the wall thereof, in order to attract parasites specifically into the interior of the hollow body, where they are killed. Bird houses in which hollow, but sealed off perching elements are present can be retrofitted with the hollow body according to the invention by inserting holes in the perching element and detachably arranging therein the means for killing the parasites. As an alternative thereto, the hollow body can be arranged in addition to the existing, optionally massive, perching elements and directly beneath the same. The hollow body according to the invention can therefore be integrated in diverse existing bird houses, without existing perching elements having to be removed.

In a preferred embodiment the hollow body has a diameter of approximately 0.5 to approximately 10 cm, preferably of approximately 2 to approximately 8 cm, more preferred of approximately 3 to approximately 6 cm. The diameter of the hollow body can be chosen as desired corresponding to the bird kept in the bird house. A smaller diameter is suitable when keeping small birds, such as ornamental birds or doves. For poultry keeping, the diameter of the perches should preferably be between approximately 3 and approximately 6 cm. For larger birds, such as, for example, birds of prey kept in zoological gardens, the diameter of the hollow body can be selected to be correspondingly larger. Furthermore, the length of the hollow body can be adapted to the bird house. Thus, the hollow body can have a length of approximately 0.1 to approximately 10 m, preferably of approximately 1 to approximately 5 metres. Using suitable supporting elements the hollow body can also be extended beyond 10 m, as is required, for example, for industrial-scale fattening farms.

In a preferred embodiment the hollow body has attractants inside. The use of attractants, for example, pheromones, enables parasites to be lured specifically into the inside of the hollow body. The efficiency with which the parasites are controlled is thereby increased. In addition, with suitable attractants parasites that would not naturally retreat into hiding places can also be lured inside the cavities.

According to a preferred embodiment the hollow body is made of wood, metal or plastics material, preferably of steel, stainless steel, PVC or of a combination of said materials. Stainless steel and plastics material in particular are easy to care for and especially durable. In addition, the shape of the cross-section of the hollow body can be individually configured corresponding to the requirements of the bird. Thus, the hollow body can have a uniform, for example, round, oval, square or rectangular cross-section.

In a preferred embodiment the parasite is an ectoparasite, preferably a tick or bird mite. Ectoparasites are capable of leaving their host and of surviving, at least for a short period, without direct contact with their host. The can therefore, optionally by following attracts, creep inside the hollow bodies where they are killed by electromagnetic radiation. The hollow body according to the invention is especially suitable for controlling poultry red mite, since this parasite leaves the host independently and spends a large part of its life cycle in dark hiding places. It is there that it lays eggs and the larval stages develop. In addition to killing adult parasites, the hollow body is therefore especially suitable for killing their eggs and developmental stages as well. Ectoparasites, such as poultry red mite, attack many different kinds of birds, primarily chickens. The bird house can therefore be a poultry shed for geese, ducks or turkeys, preferably for chickens, a dovecote, a bird house, a nest box, an aviary or a bird cage for farm birds and/or ornamental birds.

In a preferred embodiment the hollow body comprises a plurality of openings in the wall, preferably spaced at a distance apart from each other of approximately 1 to approximately 20 cm in the longitudinal direction and more preferred having a diameter that is 0.2 to 0.3 times the diameter of the hollow body. The parasites enter the inside of the hollow body by leaving the host and crawling through the openings of the hollow body. Since the distance that the parasites normally travel is not especially large, the holes should not be too far apart from one another and not too far away from the place where the host sits. In addition, the parasites prefer mostly dark hiding places, so that the frequency and size of the holes is selected so that not too much light penetrates inside the hollow body. In this connection, openings having a diameter of approximately 2 to approximately 5 mm, preferably of approximately 3 to approximately 5 mm, more preferred of approximately 4 mm and at a distance apart from each other in the longitudinal direction of approximately 1 to approximately 20 cm, preferably of approximately 5 to approximately 10 cm are preferred. The shape of the openings can be selected as desired; they may be round, oval, rectangular, triangular, elongate or square. The openings are accordingly easy to make in existing perching elements, for example, by bores. In addition, existing material or tools can be used in the industrial manufacture of hollow bodies, thus enabling the financial outlay for new acquisitions to be reduced.

In a preferred embodiment the openings are located on the top face of the wall of the hollow body. The openings are thus comparatively close to the host, that is, in close proximity to the bird that sits on the hollow body and the distance that the parasites have to travel to their hiding places is comparatively short. Alternatively or additionally, a plurality of openings can be located on the underside of the wall of the hollow body. These openings are especially suitable to removing the corpses of the parasites when cleaning. They can be swept out or flushed out through the openings on the underside. It is therefore advantageous if the openings on the underside of the wall of the hollow body have a diameter of approximately 5 to approximately 10 mm, preferably of approximately 7 mm. In this connection the number and spacing of the holes are selected such that the interior of the hollow body is still sufficiently dark for the parasites to accept it as a hiding place.

In a preferred embodiment the electromagnetic radiation is thermal radiation, infrared radiation, ultraviolet radiation or microwave radiation. All these electromagnetic radiations are suitable for killing parasites inside the hollow body. Thermal radiation is produced by a heated body, for example, a lamp, a halogen lamp, preferably of approximately 20 to 100 watt, a heating wire, a heating conductor or a heating filament emitting the heat thereof in the form of thermal radiation to the environment. The intensity of the thermal radiation is in this case primarily dependent on the surface material of the emitting body. By heating a body inside the hollow body the interior thereof and the inner surface thereof is heated to such an extent that the parasites located therein are killed. Infrared radiation having a wavelength of 780 nm to 1 mm also constitutes thermal radiation. It can be generated by means of different kinds of infrared emitters, for example, with radiant heaters, infrared lamps or ceramic infrared emitters, but is also emitted by conventional bulbs. Infrared radiation can also heat the inside of the hollow body sufficiently to kill the parasites located therein. Microwaves having a wavelength of 1 mm to 1 m are likewise used to heat objects and liquids. They do not convey heat from the outside of the objects but induce dipolar and multipolar vibrations of the molecules of the objects, in particular water molecules. The constant alignment in the alternating electromagnetic field causes these molecules to emit heat and thus heat up the irradiated object “from the inside”. In this way the parasites can be killed by themselves being heated. Microwave radiation is especially advantageous because it is largely harmless to the birds living in the bird house. For the use of microwaves it is moreover appropriate to use a metal hollow body through which the microwaves cannot penetrate. Unlike the electromagnetic radiations mentioned, ultraviolet radiation kills parasites not by heating them, but by destroying the chemical bonds of molecules. Ultraviolet radiation with wavelengths of 1 nm to 380 nm, which are generated by means of mercury-vapour lamps or mercury-vapour tubes is used, for example, to disinfect surfaces and liquids. What is known as UVC radiation having wavelengths of 100 to 280 nm is especially suitable for that purpose, since it damages primarily proteins and deoxyribonucleic acids (DNA). The birds are not exposed to the ultraviolet radiation since this can hardly leak from the hollow body.

The use of electromagnetic radiation for killing parasites inside the hollow body according to the invention therefore presents no hazard to the birds living in the bird house or to humans or animals in the area surrounding them.

Accordingly, in a preferred embodiment the means for killing the parasites comprises an electrical conductor or an electromagnetic radiation source, preferably a halogen lamp, an infrared lamp, a UV lamp or a microwave transmitter. These means are all suitable for emitting one or more of the above-described radiations, and thus for killing the parasites inside the hollow body. In order to make installation and operation of the means as simple as possible, the means is preferably operated with mains voltage.

In a preferred embodiment, the electrical conductor comprises a metal electrical conductor, preferably at least one heating conductor. Heating conductors are devices that are suitable for conducting current and in so doing emitting heat to their surroundings. The electrical conductor is activated by being connected to a power source; it heats up and emits its heat to the surroundings so that the inside and the inner surface of the hollow body are heated. Heating conductors, heating wires, heating coils, strip-type heaters and rail-type heaters are suitable as electrical conductors. The heat given off by the metal electrical conductor is directly dependent on the resistivity of the electrical conductor. This is preferably approximately 0.01 to approximately 1.5 Ωmm²/m, wherein the electrical resistance of the conductor is determined both by the length and also by the material of the conductor. The material of the conductor should therefore be selected such that on heating of the conductor it does not melt and remains resistant to corrosion despite repeated heating up and cooling down of the conductor. In a further preferred embodiment the electrical conductor therefore consists of aluminium, copper or alloys, for example, copper-nickel alloys, chrome-nickel alloys, copper-tin alloys, brass or ferritic chromium steels that may contain aluminium. Depending on the nickel content, copper-nickel alloys have a resistivity of 0.025 to 0.49 Ωmm²/m. Copper-tin alloys having a resistivity of approximately 0.13 Ωmm²/m are especially suitable for use as a metal electrical conductor owing to their high corrosion resistance. Brass is suitable as a heat conductor owing it its advantageous corrosion behaviour and its very low conductivity.

In a preferred embodiment the means for killing the parasites comprises a metal electrical conductor that for activation thereof is connected at one end to a voltage source. The opposite end of the electrical conductor can be connected to the hollow body, provided that the hollow body consists of metal. In this embodiment the hollow body is used as return conductor for the metal electrical conductor. This system can easily be installed in existing bird houses, in which, for example, massive perching elements are already present. For that purpose a metal tube is used as the hollow body and is installed below the existing perches. In this manner the birds do not come into contact with the hollow body so that injuries due to electrical accidents are avoided. In addition, by using the hollow body as return conductor the consumption of material required for the high-quality electrical conductor is reduced.

In an alternative embodiment, a second metal electrical conductor inside the hollow body can serve as return conductor. The completely internal conductor system poses no risk that the birds will come into contact with the electrical conductor. In addition, the completely internal conductor can be integrated in any perch, regardless of the material of which this is made. To stabilise the electrical conductor inside the hollow body and to ensure that no contact between the electrical conductor and the hollow body occurs, the means for killing the parasites preferably comprises one or more insulators. Post insulators in particular, preferably insulating discs, and thermoplastic insulators, preferably star-shaped thermoplastic insulators, are suitable for this purpose. Insulating discs are simple and cheap and therefore especially suitable for producing the hollow body according to the invention quickly and inexpensively, for example, for integrating it into existing bird houses. On the other hand, star-shaped insulators are suitable primarily for industrial manufacture of especially long perches, as required for fattening farms.

In a preferred embodiment, by activating the means the inner surface of the hollow body has a temperature suitable for killing the parasites, preferably a temperature of approximately 50 to approximately 100° C. At these temperatures both adult parasites and eggs and developmental stages of the parasites are killed. In an especially preferred embodiment, the inner surface of the hollow body has this temperature by activation of the means for approximately 10 to 15 seconds. Such a quick heating of the hollow body to approximately 50 to approximately 100° C. is suitable for killing the parasites before they are able to flee from the hollow body. In addition the short heating time prevents the outer surface of the hollow body, with which the birds may come into contact, from becoming hot. Disturbance to the birds can thus be avoided.

In a preferred embodiment, the means for killing parasites has a maximum temperature cutout. This serves to switch off the means automatically as soon as the desired temperature, preferably a temperature between approximately 50 and approximately 100° has been reached. This permits a simple and fully automatic operation of the means and ensures that the hollow body does not become overheated. Automatic switching off of the means additionally prevents excessive energy consumption. The maximum temperature cutout can comprise, for example, a temperature sensor for determining the temperature inside the hollow body. If the means for killing the parasites comprises an electrical conductor, the temperature thereof can be monitored via the change in the resistance thereof, which changes as the temperature increases.

In a preferred embodiment, the radiation source is shorter than the hollow body. In this manner the radiation source can be moved through the hollow body and thus the parasites that are located in the hollow body can be killed. The radiation source is in this case preferably arranged on a sliding carriage, which comprises a traction device with which the sliding carriage can be moved in the hollow body. The traction device can comprise, for example, a cable, a chain, a feed chain and/or a flexible electrical lead that serves for power supply to the radiation source. The traction device preferably comprises a clamp for mechanical strain relief. By means of the traction device the radiation source is drawn through the hollow body and thus the parasites along the entire hollow body are killed. In order to ensure a continuous movement and easy operation of the traction device, this preferably comprises at least one drum. In an especially preferred embodiment, the traction device comprises additionally an electric motor for movement of the drum. The traction device with the electromagnetic radiation source can therefore be fully automated and can be moved at a constant and definable traction speed through the hollow body. It is also possible to operate the device by a time switch or, if appropriate, by means of a computer, without manual operation being needed.

In a preferred embodiment, the sliding carriage comprises a glass tube, in which the electromagnetic radiation source is arranged. This glass tube is preferably made of a high-strength material of high radiolucency, such as, for example, quartz glass, which is especially durable. The glass tube protects the radiation source and at the same time is easy to clean.

In a preferred embodiment, the sliding carriage comprises at least one sliding aid, preferably a runner and/or a cam. The sliding carriage can thus be moved through the hollow body reliably and at a constant distance from the inner wall. In order to centre the sliding carriage inside the hollow body and, if appropriate, compensate for any unevenness of the hollow body, the sliding aid of the sliding carriage can be spring-mounted or comprise a roller or a ball bearing, wherein the roller or the ball bearing is preferably arranged at the end of the sliding carriage.

In a preferred embodiment, the means for killing parasites further comprises a cleaning device. This can comprise, for example, a brush, a sponge, a cloth plug and/or a foam plug. By arranging the cleaning device on the traction device, it is moved together with the radiation source through the hollow body. The corpses of the killed parasites can thus be removed from the hollow body immediately after they have been killed. This contributes additionally to the hygiene of the bird house and avoids undue contamination of the traction device. Alternatively, the cleaning device can be arranged on a traction device that moves the cleaning device along an electrical conductor through the hollow body.

A further aspect of the invention concerns a method for controlling parasites in a bird house by means of a hollow body as described above. By killing the parasites inside the hollow body, in which they congregate, the birds are not disturbed by control of the parasites. The hollow body can be operated from outside the bird house or be controlled automatically. The bird house therefore need not be entered and the birds do not have to be removed from the bird house for the parasites to be killed. In addition, the hollow body remains in the bird house as the parasites are being killed. It also does not have to be removed from the bird house after the parasites have been killed. Furthermore, the method according to the invention can be carried out without the need to use insecticides, whereby the chemical hazard for humans and animals is substantially reduced.

In a preferred embodiment, the parasites inside the hollow body are killed at intervals of approximately 2 to approximately 4 weeks. As a result, it is possible to control the parasites continuously, without the birds being disturbed by the treatment or by cleaning of the bird house.

In a preferred embodiment, the inner surface of the hollow body is heated by activating the means to a temperature that is suitable for killing the parasites, preferably to a temperature of approximately 50 to approximately 100° C. This temperature is suitable for killing both adult parasites and their eggs and developmental stages. In an especially preferred embodiment, the inner surface of the hollow body is heated within approximately 10 to approximately 15 seconds to a temperature that is suitable for killing the parasites. The rapid heating kills the parasites before they are able to flee from the hollow body or before the surface of the hollow body, with which the birds may come into contact, becomes hot.

In a preferred embodiment, the inner surface of the hollow body is heated by moving a radiation source through the hollow body, wherein the inner surface of the hollow body is heated to a temperature that is suitable for killing the parasites. The temperature to which the parasites are exposed can be regulated by regulating the speed at which the radiation source is moved through the hollow body. In the case of a very serve infestation, the radiation source can be moved correspondingly slowly in order to reach a relatively high temperature. In addition, the temperature can also be influenced by the intensity of the electromagnetic radiation and by the type of electromagnetic radiation.

The invention relates further to the use of a perch for birds for controlling parasites, having at least one opening in the wall of the perch, for admitting the parasites into the inside of the perch, and a means arranged detachably inside for killing the parasites. Because the means can be activated in a predetermined manner and emits electromagnetic radiation, the parasites inside the perch are killed without this having to be removed for the killing or having to be removed subsequently from the bird sheds. The daily routine of the birds thus remains uninterrupted. In addition, neither animals nor humans in the area surrounding the birds are endangered by the use of insecticides or silicate dust. Perches are especially suitable for controlling parasites since they form the immediate environment of the bird. Unlike conventional perches, which provide no refuge for parasites, the perch used to control parasites has openings in the wall thereof so that the parasites can crawl inside the perch, where they are killed. Conventional perches, for example, perches that have already been installed, can be used for controlling parasites by subsequent insertion of bores and a means that emits electromagnetic radiation.

In a preferred embodiment, the electromagnetic radiation that is emitted by the means that is located in the perch used to control parasites is thermal radiation, infrared radiation, ultraviolet radiation or microwave radiation. These electromagnetic radiations are especially suitable for killing parasites inside the perch.

### EXAMPLES

1. Parasite trap for installation in a poultry shed

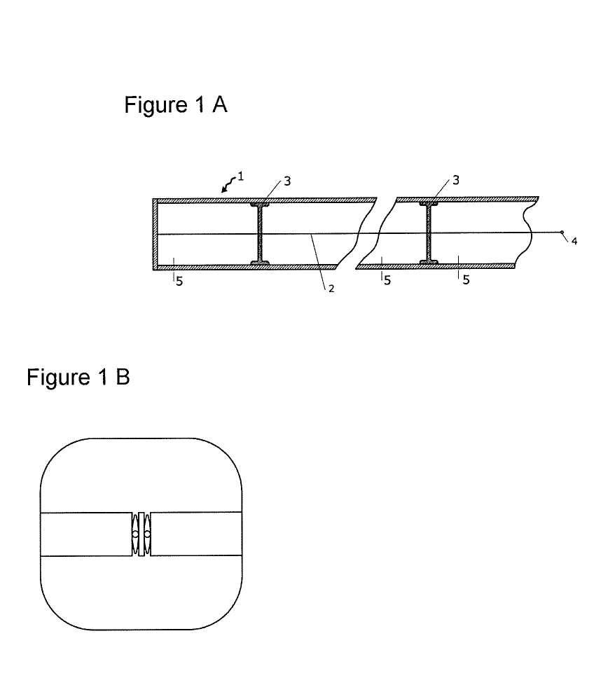

FIG. 1A shows a tubular hollow body 1 in cross-section, inside which an electrical conductor 2 is arranged. The hollow body 1, having a diameter of 4 cm, is made of metal. On the underside of the hollow body 1 there are bores 5 of a diameter of 8 mm arranged at intervals of 5 cm. The electrical conductor 2 inside the hollow body 1 consists of copper and is connected at one end via a conductor connection 4 to a voltage source (not shown) having a mains voltage of 230 volt. At its other end the electrical conductor 2 is connected to the hollow body 1 of metal, which serves as return conductor. Symmetrical insulating discs 3 fix the electrical conductor 2 at a sufficient distance from the inner wall of the hollow body 1. FIG. 1B shows the insulating disc 3, which serves both for electrical insulation and for centring the electrical conductor 2 inside the hollow body 1. In the hollow body 1 there is additionally arranged a maximum temperature cutout (not shown), which measures the strength of the current flowing through the electrical conductor 2. The electrical resistance of the electrical conductor 2 rises with the temperature thereof. At a constant voltage the current strength drops as the temperature of the electrical conductor 2 rises, and thus provides a reliable measure of the temperature reached. Immediately after the current is switched on, the maximum temperature cutout determines an initial current value and automatically switches off the current supply as soon as the current value falls below a fixed end current value, corresponding to a temperature inside the hollow body 1 of approximately 75° C.

This device is installed in a poultry shed below the perching elements of the birds. Parasites such as poultry red mite, once they have attacked a bird and sucked blood, retreat through the bores 5 on the underside into the inside of the hollow body 1. They also lay their eggs, from which the larval and nymph stages develop, inside the hollow body. At intervals of 2-4 weeks the electrical conductor 2 is activated by passing current through it, so that the interior and the inner surface of the hollow body 1 heat up to approximately 75° C. The intense heating causes the parasites located on the surface of the hollow body 1 to die. As soon as a temperature of approximately 75° C. is reached, the current supply is interrupted by the maximum temperature cutout and the electrical conductor 2 is switched off. In the event of a severe infestation the electrical conductor 2 is activated more frequently, for instance once a week. To clean the hollow body 1 the electrical conductor 2 is removed from the hollow body 1 about once a year and cleaned.

The parasite trap described is simple and inexpensive to manufacture and can be integrated in any poultry shed, optionally later on. Above all, it lends itself to retrofitting of medium and relatively small poultry sheds, since it can be produced on site and according to the conditions of the shed.

2. Perch for integration in a birdcage

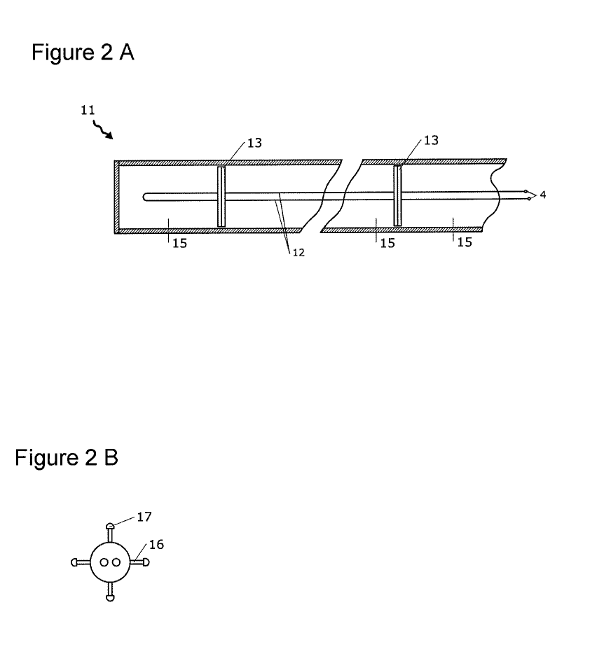

FIG. 2A shows a tubular perch 11 in cross-section, in which two heating conductors 12 are arranged. The perch 11 is made of plastics material and serves to control parasites in a birdcage for ornamental birds. It is 25 cm long and has a diameter of 2 cm. On the surface thereof is a plurality of openings 15 having a diameter of 2 mm arranged at a distance apart of approximately 1 cm. Two copper-nickel wires serve as heating conductors 12 and at one end are connected to the terminals of a voltage source (not shown) and at the opposite end are connected to each other. A conventional battery is provided as the voltage source, which is switched on and off by way of an automatic control means (not shown). The thermoplastic insulators 13 fix the heating conductors 12 at an adequate distance apart from one another and from the inner surface of the perch 11. FIG. 2B shows a star-shaped thermoplastic insulator 13 with four insulator fingers 16 at the outer end of each of which there is a runner 17.

The perch 11 described is installed in a birdcage so that the parasites, as soon as they leave the bird, enter the perch 11. By activating the heating conductor 12 the inner surface of the perch 11 is heated to 50-75° C. and the parasites located in the perch are killed.

This perch 11 can be manufactured on an industrial scale and integrated into any birdcage, optionally later on.

3. Perch for installation in a chicken shed

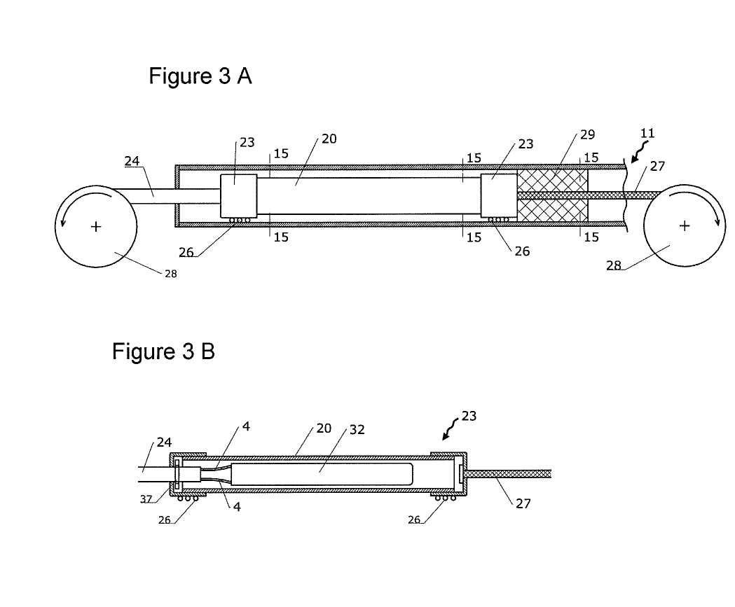

FIG. 3A shows a perch 11 made of metal for chickens, which is designed as a parasite trap. The perch 11 has a diameter of 4 cm and a length of 10-15 m. A plurality of openings 15 of a diameter of 5 mm are arranged on the top face, spaced a distance of 5 cm apart. A plurality of openings 15 of a diameter of 7 mm are arranged on the underside of the perch 11, spaced a distance of 20 cm apart from each other. Inside the perch 11 is a sliding carriage 23, on which a glass tube 20 is mounted. FIG. 3B shows a detail of the glass tube 20 with sliding carriage 23. A microwave transmitter 32, which is connected via electrical conductor connectors 4 to a flexible electrical connection cable 24, is arranged inside the glass tube 20. The electrical connection cable 24 is mounted on the sliding carriage 23 with a clamp 37 for strain relief. The sliding carriage 23 is moved on rollers 26 through the perch 11. For that purpose a traction cable 27 and the electrical connection cable 24 are secured one to each end of the sliding carriage 23. Both are guided over drums 28, so that the sliding carriage 23 is moved through the perch 11 by operating the drums 28. A cloth plug 29 is also mounted on the sliding carriage 232, which is moved simultaneously with the sliding carriage 23 through the perch 11 and at the same time cleans the inside of the perch 11.

This device can be manufactured on an industrial scale and is especially suitable for effectively controlling poultry red mite in large chicken sheds, such as are found in fattening farms, with little manpower. Because the corpses of the dead mites are swept by means of the cloth plug 29 through the openings 15 on the underside of the perch 11, no additional and time-consuming cleaning of the perch 11 is necessary.

4. Perch for integration in an aviary

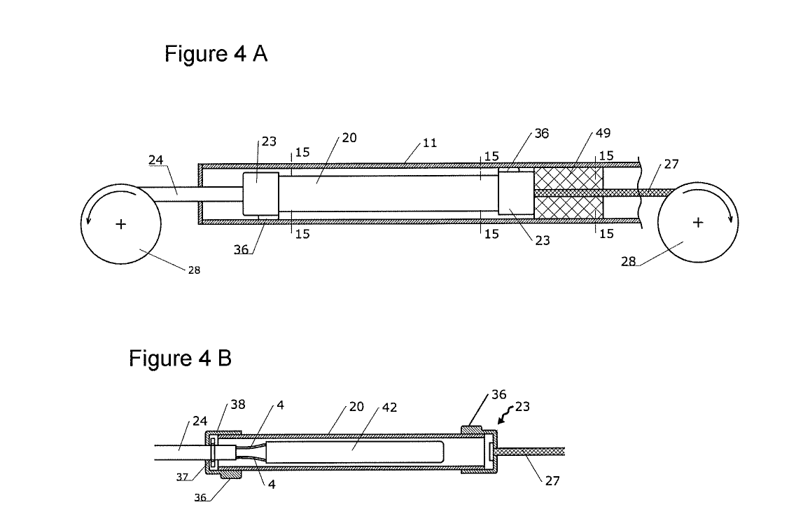

FIG. 4A shows a perch 11 of plastics material, which is used by birds as a landing or roosting place and is designed to control bird parasites in a zoological aviary. The perch 11 has a diameter of approximately 8 cm and a length of 2 m. On the top face and underside of the perch 11 there are openings 15 spaced a distance of 20 cm apart and having a diameter of approximately 6 mm. Inside the perch 11 a glass tube 20 made of quartz glass is mounted on a sliding carriage 23. FIG. 4B shows the sliding carriage 23 with the glass tube 20, in which there is an infrared lamp 42. The sliding carriage 23 with the infrared lamp 42 has a length of 25 cm and is moved by means of a traction device comprising a traction cable 27 and two drums 28.

Fixed closure caps 38 at the ends of the glass tube 20 connect the glass tube 20 to the traction cable 27 and the electrical connection cable 24. Runners 36 distributed around the circumference of the sliding carriage 23 ensure the glass tube 20 with the infrared lamp 42 is sufficiently spaced from the inner surface of the perch 11 and reduce frictional forces as the sliding carriage 23 is moved through the perch 11. An additional spring mounting (not shown) of the runners 36 centres the sliding carriage 23 in a radial direction within the perch 11 and compensates for unevenness of the inner surface. A brush 49 for cleaning the perch 11 is also mounted on the sliding carriage 23.

When birds settle on the perch 11, the parasites crawl through the openings 15 into the inside of the perch 11. There they are killed by moving the sliding carriage 23 with the activated infrared lamp 42 through the perch 11. In the process, the inner surface of the perch 11 is heated to 75-100° C., so that both adult parasites and the eggs and larvae thereof are killed. Simultaneously with the sliding carriage 23 the brush 49 is also moved through the perch 11, so that the dead parasites are swept out directly through the openings 15 located on the underside of the perch 11.

By using conventional and inexpensive materials, such as plastics tubes and infrared lamps, the device is simple and cheap to manufacture and can be made up in zoological gardens as appropriate for the aviaries present therein.

### REFERENCES

Chirico J., Tauson R., Traps containing acaricides for the control of Dermanyssus gallinae, Vet Parasitol. 2002 Dec. 11;110(1-2):109-16.

DE 10 2005 031 976 A1

DE 10 2008 006 683 A1

DE 198 08 745 A1

### LIST OF REFERENCE NUMBERS

1 Hollow body

2 Electrical conductor

3 Insulating disc

4 Conductor connection

5 Bore

11 Perch

12 Heating conductor

13 Thermoplastic insulator

15 Opening

16 Insulator finger

17 Runner

20 Glass tube

23 Sliding carriage

24 Electrical connection cable

26 Roller

27 Traction cable

28 Drum

29 Cloth plug

32 Microwave transmitter

36 Runner

37 Clamp

38 Closure cap

42 Infrared lamp

49 Brush

1. An elongate hollow body (1) for controlling parasites in a bird house, having at least one opening (15) in the wall of the hollow body (1), for admitting the parasites into the inside of the hollow body (1), and a means arranged detachably inside for killing the parasites, wherein the means can be activated in a predetermined manner and emits electromagnetic radiation, and in that the hollow body (1) remains in the bird house as the parasites are being killed.

2. The hollow body (1) according to claim 1, wherein the hollow body (1) is a perching element for birds, preferably a perch or approach perch, more preferred a perch (11) at a resting place within the bird house.

3. The hollow body (1) according to claim 1, wherein the hollow body (1) has a diameter of approximately 0.5 to approximately 10 cm, preferably of approximately 2 to approximately 8 cm, more preferred of approximately 3 to approximately 6 cm.

4. The hollow body (1) according to claim 1, wherein the hollow body (1) comprises a plurality of openings (15) in the wall, preferably spaced at a distance apart from each other of approximately 1 to approximately 20 cm in the longitudinal direction and more preferred having a diameter that is 0.2 to 0.3 times the diameter of the hollow body (1).

5. The hollow body (1) according to claim 1, wherein the electromagnetic radiation is thermal radiation, infrared radiation, ultraviolet radiation or microwave radiation.

6. The hollow body (1) according claim 1, wherein the means comprises an electrical conductor (2) or an electromagnetic radiation source, preferably a halogen lamp, an infrared lamp (42), a UV lamp or a microwave transmitter (32).

7. The hollow body (1) according to claim 6, wherein the electrical conductor (2) comprises a metal electrical conductor (2), preferably at least one heating conductor (12).

8. The hollow body (1) according to claim 6, wherein the means comprises a sliding carriage (23), on which the electromagnetic radiation source is arranged, and a traction device, with which the sliding carriage (23) can be moved in the hollow body (1).

9. The hollow body (1) according to claim 1, wherein, by activating the means, the inner surface of the hollow body (1) has a temperature suitable for killing the parasites, preferably a temperature of approximately 50 to approximately 100° C.

10. The hollow body (1) according to claim 1, wherein the means further comprises a cleaning device.

11. The method for controlling parasites in a bird house by means of a hollow body (1) according to claim 1, wherein the parasites are killed inside the hollow body (1) in which they congregate.

12. The method according to claim 11, wherein, by activating the means, the inner surface of the hollow body (1) is heated to a temperature suitable for killing the parasites, preferably to a temperature of approximately 50 to approximately 100° C.

13. The method according to claim 11, wherein, by activating the means for approximately 10 to 15 seconds, the inner surface of the hollow body (1) has a temperature suitable for killing the parasites, preferably a temperature of approximately 50 to approximately 100° C.

14. A method for controlling parasites which comprises a perch (11) for birds, having at least one opening (15) in the wall of the perch (11), for admitting the parasites into the inside of the perch (11), and a means arranged detachably inside for killing the parasites, wherein the means can be activated in a predetermined manner and emits electromagnetic radiation.

15. The method according to claim 14, wherein the electromagnetic radiation emitted by the means for killing the parasites is thermal radiation, infrared radiation, ultraviolet radiation or microwave radiation.
